(19) United States
(12) Patent Application Publication
(10) Pub. No.: US 2004/0203341 A1
(43) Pub. Date: Oct. 14, 2004

(54) Wireless call hitchhiker

(76) Inventors: Peter J. Armbruster, Chandler, AZ (US); Mark L. Shaughnessy, Phoenix, AZ (US); Bradley R. Schaefer, Chandler, AZ (US)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/174,606

(22) Filed: Jun. 19, 2002

(51) Int. Cl. H04B 7/15

(52) U.S. Cl. 455/11.1; 455/422.1

(57) ABSTRACT

A hitchhiker device (20) has a wireless communication capability. The hitchhiker device is located in a non-network area (10) and requires the transmission of a wireless message. The hitchhiker device requests via an RF link (25) a donor device (30). The hitchhiker device transmits the message to the donor device. The donor device stores the wireless message. Subsequently, the donor is relocated to a wireless area and transmits the stored message via a network link (35).

### BACKGROUND OF THE INVENTION

The present invention pertains to communication systems and more particularly to extending wireless coverage to areas that typically are unsuitable for providing wireless coverage.

Intelligent devices, such as smart vending machines, automatic teller machines (ATM's), etc., are becoming more pervasive in today's society. Such intelligent devices are located in train stations or train tunnels, basements of buildings or other areas which are inhospitable to wireless type communications.

These intelligent devices rely upon cellular telephone technology to sent telemetry data (e.g., tamper alarms, inventory, maintenance requests) to a central location. These devices cannot communicate cellularly when they are installed in areas without cellular phone coverage, such as in buildings train stations or tunnels.

Further, other intelligent devices, whether permanent or portable may be located in areas that are currently inhospitable to wireless or cellular communication, but the intelligent device requires a wireless or cellular communication. Such devices may include two-way pagers, cell phones, internet devices, etc.

Accordingly, it would be highly desirable to have an arrangement for extending wireless coverage to intelligent devices that rely upon cellular or other wide area wireless technology. Further such an arrangement is desirable for extending communication coverage when such intelligent devices are permanently installed or located for a period of time in areas that are inhospitable to wireless communication coverage.

### BRIEF DESCRIPTION OF THE DRAWING

FIG. 1 is a block diagram of an arrangement embodying the present invention in an operating environment.

FIG. 2 is a block diagram of another facet of the present invention in its operating environment.

FIG. 3 is a block diagram depicting the principles of operation in accordance with the present invention.

### DETAILED DESCRIPTION OF THE PREFERRED EMBODIMENT

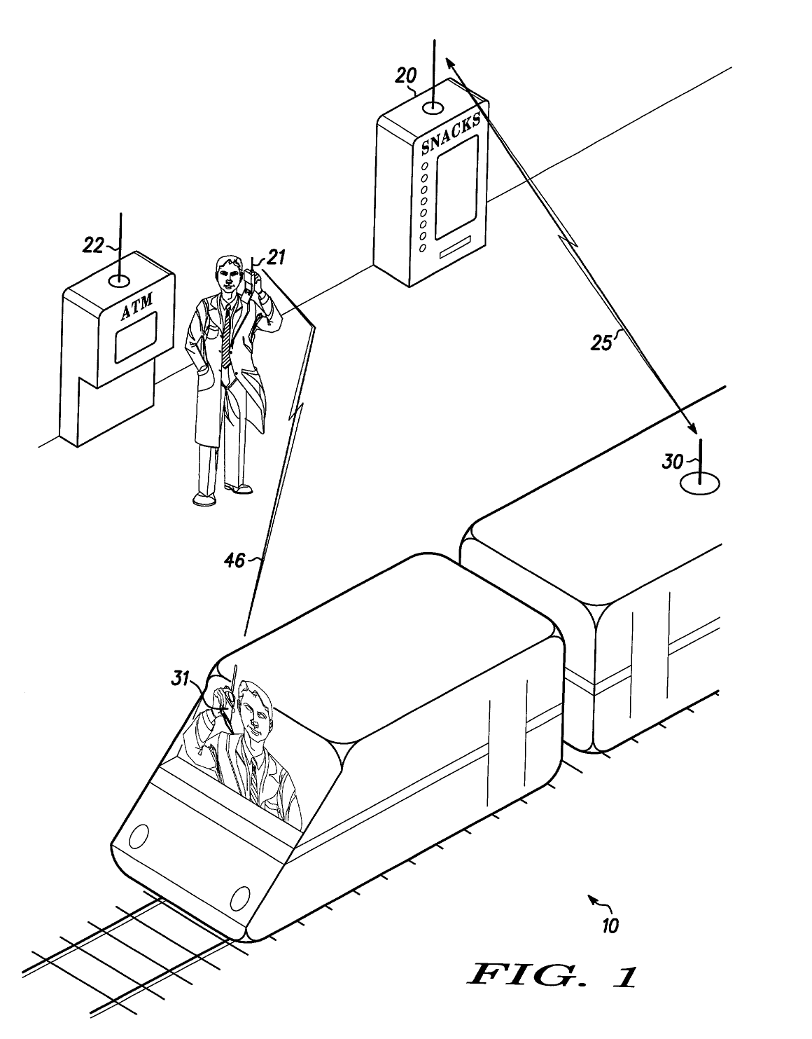

FIG. 1 is a block diagram depicting an embodiment of the present invention in its operating environment. FIG. 1 depicts a vending machine including a cellular/short-range RF communication device 20 as well as a ATM user with a pager or cell phone 21 having similar features. In fact, the ATM 22 may include a communication device with these features.

Vending machines typically communicate with cellular communication device 20 via a cellular network (not shown). Since, in the depiction of FIG. 1, the vending machine is typically located in a non-wireless network area, for example, inside a subway or train station or a building basement or elevator, etc. 10. Vending machine 20 will communicate via link 25 via a relatively short-range communication to a donor device 30. Further, wireless phone or 2-way pagers, etc. may be required to send messages, human voice data, packet data, etc.

Short-range non-cellular communication links 25 and 46 may be achieved by a “Bluetooth” arrangement or other similar short-distance communication arrangements, such as infrared or wireless local area networks. Various information related to Bluetooth technology may be found via the Internet at http://www.bluetooth.com.

Donor 30 is required to have a compatible communicator device implemented via Bluetooth or other short-range communication technology as part of the wireless or cellular/short range RF apparatus 30. The Bluetooth/cellular donor device 30 may be permanently attached to a train 30 or may be carried by a passenger, for example, as a cell phone or a pager 31. In the case of a paging unit or cell phone 21 which wishes to send a wireless or cellular message, connection will be made via link 46 to request the services of a donor device 31, for example. Donor device 30 may serve for hitchhiker devices 20 and 22 too.

When vending machine communication device 20, cellular device 21 or ATM communication device 22 requires a wireless communication, the hitchhiker device will transmit a request for a donor device via RF link 25 or 46, for example. When donor devices 30 and 31 receive the request for a donor device, they will respond via non-cellular RF links 25 and 46 respectively. Hitchhiker communication device 20-22 will select a donor communication device 30-31 to carry its message. Hence, the message of devices 20-22 is said to hitchhike along with the donor device which is selected.

When vending machine communication device 20 or network communication device 21 detects the presence of a donor, 30 or 31 respectively, devices 20 and 21 will enable the donor by sending the required message via links 25 and 46 respectively. The message is transmitted via non-cellular links 25 and 46 to the donor 30 or 31 respectively. Donors 30 and 31 then store the message for subsequent retransmission via wireless network 60. Network 60 may be a cellular, wide area wireless data or dispatch or satellite network.

Since donor communication devices 30 and 31 are on a train 32, for example, or other moving vehicle or device, such as an elevator, train 32 will move to a network area in which there is access to a wireless network.

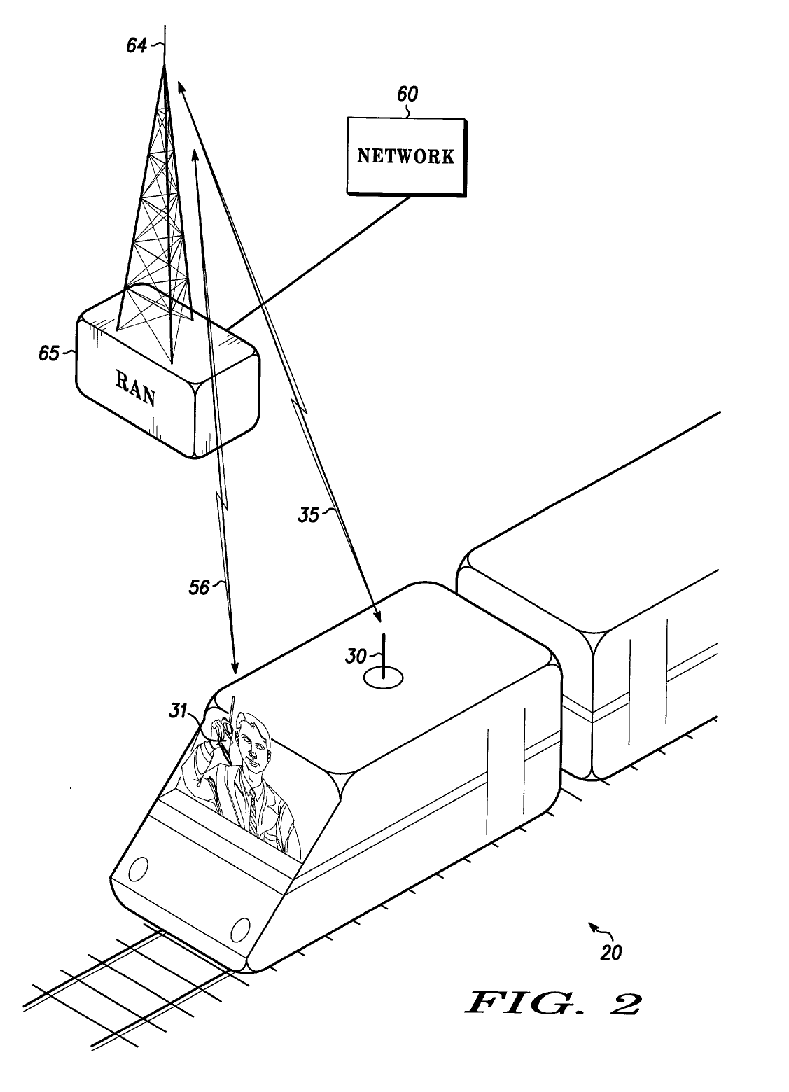

FIG. 2 is a block diagram depicting donor communication devices 30 and 31 in a new wireless area within the range of a cellular or wireless network 60 that has a radio access network 65. Donor devices 30 and 31 will detect when they are within the range of radio access network 65.

When the donor communication devices 30 and 31 are within range of radio access network 65 of the network 60, they will transmit any stored messages via RF links 35 and 46 to the radio access network 65. It will be as if these messages were transmitted by the hitchhiker communication devices 20, 21 or 22 which originated the message, except it will be delayed slightly in time.

In this way the vending machine will be able to communicate its telemetry data such as alarms, inventory and maintenance requests to its managing central location. Similarly, messages, human user data, packet data or pages from communication device 21 and 22 may be routed to their appropriate destinations. This has the effect of giving devices 20, 21 and 22 which are permanently or temporarily located outside of wireless coverage, the access to a wireless or cellular network for communication purposes.

The process may also be reversed in that the communication device 20, 21 and 22 may receive communications from donor communication devices 30 and 31 respectively. The donor device 30 will request any messages from network 60 and store them. Donor device 30 will move to the proximity of hitchhiker device 20 and send the message or data packet to hitchhiker device 20 via link 25, for example.

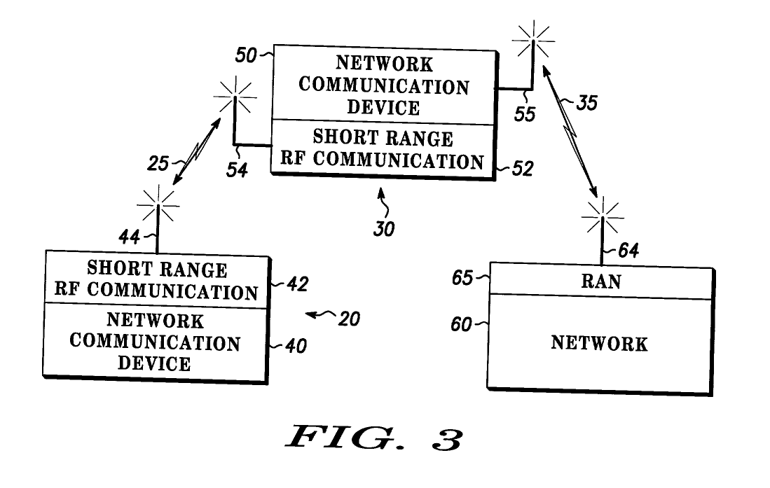

FIG. 3 depicts a detailed description of the hitchhiker communication arrangement of FIGS. 1 and 2. Communication device 20 which may be included in a vending machine, cell phone, ATM or the like, is not within the range of a typical cellular or wireless network 60.

Hitchhiker communication device 20 includes a wireless or cellular communication device 40 and a short-range RF communication device 42. Antenna 44 provides for the transmission link 25 for the short-range RF communication device 42.

Donor communication device 30 is coupled to hitchhiker communication device 20 by link 25. RF link 25 is a short-range communication link, such as those supported by Bluetooth devices, infrared devices or other RF links mentioned above. Donor communication device 30 includes a short-range RF communication device 52 that communicates via antenna 54 and link 25 with antenna 44 of hitchhiker communication device 20. Donor communication device 30 also includes a cellular or wireless network communication device 50 and corresponding cellular antenna 54.

Donor communication device 30 communicates via link 35 with network 60 through the radio access network (RAN) 65 which interfaces with network 60. Network 60 includes an antenna 64 of RAN 65 for establishing communication link 35 with donor communication device antenna 54.

Short-range RF communication devices 42 and 52 may be implemented with a Bluetooth scheme or other short-range communication arrangements indicator hereinabove.

When hitchhiker communication device 20, for example, determines that it needs to send a message, short-range RF communication device 42 broadcasts over antenna 44 a request for a donor communication device. When a donor communication device such as donor 30 accepts the request, communication link 25 is established between short-range RF communication device 52 and short-range communication device 42. Hitchhiker communication device 20 then transmits the message it wishes to send via link 25 to donor communication device 30. Donor communication device 30 stores the message for some period of time.

When donor communication device 30 has access to network 60, the previously stored message of donor device 30 is transmitted to network 60 via link 35. This message was originally transmitted from hitchhiker communication device 20 to donor communication device 30. Network 60 then routes the message in a typical manner. The transmission of the previously stored message may occur several times for a number of previously stored messages that have “hitchhiked” with donor communication device 30 in its travels.

In this way wireless messages or calls transmitted by a communication device without access to a cellular wireless network may hitchhike with a donor device. Subsequently, the donor device may transmit the message or messages to and through a wireless network, when it has access to a network link.

The benefits of the hitchhiker/donor arrangement are that devices that are permanently or temporarily unavailable to wireless network may gain access to the wireless network to transmit important information by use of an intermediary or donor communication device. Donor communication devices may be provided as a service or individuals may be incentivized to allow their communication device to automatically provide such services. This arrangement extends wireless communication to places that are typically inhospitable to establishing wireless communications. Further, this arrangement combines localized short-range RF communication via a Bluetooth arrangement or other means with long-range cellular communications.

Although the preferred embodiment of the invention has been illustrated, and that form described in detail, it will be readily apparent to those skilled in the art that various modifications may be made therein without departing from the spirit of the present invention or from the scope of the appended claims.

1. A wireless communication arrangement for wireless service in a non-network area comprising:
a hitchhiker device including a communicator, the hitchhiker device located in the non-network area;
a donor device including a communicator, the donor device receiving a communication from the hitchhiker device;
the donor device is moved to a network area; and
in the network area, the donor device transmitting the communication to a network.

2. A wireless communication arrangement as claimed in claim 1, wherein the hitchhiker device includes a network device coupled to the communicator, the communicator for transmitting the communication.

3. The wireless communication arrangement as claimed in claim 2, wherein the donor device includes a network device for transmitting the communication to the network.

4. The wireless communication arrangement as claimed in claim 3, wherein the donor device stores the communication.

5. The wireless communication arrangement as claimed in claim 4, wherein when the donor device is in a proximity of the network, the network device of the donor device transmits the stored communication to the network.

6. The wireless communication arrangement as claimed in claim 1, wherein the donor device moves from the non-network area to the network area and vice versa.

7. The wireless communication arrangement as claimed in claim 1, wherein the communicator of the hitchhiker device is coupled to the communicator of the donor device via an RF link.

8. The wireless communication arrangement as claimed in claim 7, wherein the RF link includes a Bluetooth link.

9. The wireless communication arrangement as claimed in claim 7, wherein the RF link includes an infrared link.

10. The wireless communication arrangement as claimed in claim 7, wherein the RF link includes a wireless local area network link.

11. The wireless communication arrangement as claimed in claim 1, wherein:
the network includes a cellular network;
the communicator of the donor device and of the hitchhiker device includes a non-cellular device; and
the network area includes a cellular network area.

12. A method for wireless communications in a non-network area comprising the steps of:
requesting by a hitchhiker device a donor device;
sending a wireless message from the hitchhiker device to the donor device;
moving the donor device from the non-network area to a network area; and
transmitting the wireless message by the donor device to a network.

13. The wireless communication method as claimed in claim 12, wherein there is further included a step of responding by the donor device to the request of the hitchhiker device.

14. The wireless r communication method as claimed in claim 13, wherein the step of sending the wireless message is performed subsequent to the step of responding by the donor device.

15. The wireless communication method as claimed in claim 12, wherein there is further included a step of storing by the donor device by the wireless message.

16. The wireless communication method as claimed in claim 15, wherein the step of storing is performed after the step of sending and prior to the step of moving.

17. The wireless communication method as claimed in claim 12, wherein:
the network includes a cellular network;
the wireless message includes a cellular message;
the network area includes a cellular network area; and
the donor device includes a cellular device.

18. A wireless communication method for sending a message from a network area to a non-network area comprising the steps of:
requesting by a donor device in the network area the message for a hitchhiker device;
moving the donor device from the network area to the non-network area; and
sending the message from the donor device to the hitchhiker device located in the non-network area.

19. The wireless communication method as claimed in claim 18, wherein there if further included a step of storing by the donor device the message.

20. The wireless communication method as claimed in claim 19, wherein the step of storing the message is performed after the step of requesting and prior to the step of moving.

21. The wireless communication method as claimed in claim 18, wherein:
the network area includes a cellular network area;
the message includes a cellular message; and
the donor device includes a cellular device.
